(19) United States
(12) Patent Application Publication
(10) Pub. No.: US 2025/0158093 A1
(43) Pub. Date: May 15, 2025

(54) Fuel Cell System, Vehicle, Method for Controlling a Fuel Cell Assembly, and Computer Program

(71) Applicant: Bayerische Motoren Werke Aktiengesellschaft, Muenchen (DE)

(72) Inventors: Volker FORMANSKI, Ismaning (DE); Daniel WITZEL, Althegnenberg (DE)

(21) Appl. No.: 18/838,690

(22) PCT Filed: Mar. 8, 2023
(86) PCT No.: PCT/EP2023/055875

§ 371 Date: Aug. 15, 2024

(30) Foreign Application Priority Data
Mar. 8, 2022 (DE) 10 2022 105 406.3

(51) Int. Cl. H01M 8/04029; H01M 8/0432; H01M 8/0438; H01M 8/04858; H01M 8/04992

(52) U.S. Cl. CPC H01M 8/04029; H01M 8/04358; H01M 8/04417; H01M 8/0494; H01M 8/04992; H01M 2250/20

(57) ABSTRACT

A fuel cell system for a vehicle includes a cooling circuit with a fuel cell assembly and at least one cooler which is fluidically connected to the fuel cell assembly, a data ascertaining device which is designed to ascertain first data that represents a first cooling power of the cooler, and a controller. The first cooling power is an actual cooling power, wherein the controller is designed to obtain the first data, ascertain second data on the basis of the first data, determine a maximally permissible electric output of the fuel cell assembly on the basis of the second data, and control the electric output to be produced by the fuel cell assembly such that the electric output is at least temporarily at most as high as the maximally permissible electric output. The second data represents a second cooling power of the cooler at a specified maximally permissible temperature of a coolant designed to circulate in the cooling circuit. A vehicle, a method, and a computer program are also described.

### BACKGROUND AND SUMMARY

The technology disclosed here relates to a fuel cell system for a vehicle, a vehicle having the fuel cell system, a method for controlling a fuel cell assembly of such a fuel cell system, and a computer program product.

Fuel cells used in vehicles, (for example, land, water, or ground vehicles) are generally temperature controlled, in particular cooled by way of a cooling circuit, in order to be able to be operated in a desired temperature range. Low-temperature fuel cells, such as polymer electrolyte fuel cells, normally have operating temperatures in the range of 60° C. to 95° C. Higher operating temperatures are also conceivable. The less the real, actual operating temperature deviates from a target operating temperature of a fuel cell, the more efficiently the fuel cell can operate.

On the other hand, the heat emitted by the fuel cell to a coolant circulating in the cooling circuit can scale significantly with the electric output generated by the fuel cell. That is, in general more heat is emitted to the coolant in the event of high electric outputs of the fuel cell than in the case of low electric outputs. When the coolant overheats in this way, it can be provided that the electric output of the fuel cell is strongly throttled in order to protect the fuel cell from damage.

It is a preferred object of the technology disclosed here to reduce or eliminate at least one disadvantage of a previously known solution or to propose an alternative solution. It is in particular a preferred object of the technology disclosed here to provide a fuel cell system for a vehicle, which can be operated efficiently, safely, and comparatively easily even in the event of varying ambient temperatures. In addition, it is an object of the present technology to provide a corresponding vehicle, a corresponding method for controlling a fuel cell assembly of a fuel cell system, and a corresponding computer program. Further preferred objects can result from the advantageous effects of the technology disclosed here.

The object(s) may be achieved by the subject matter of the independent claims. The dependent claims represent preferred embodiments.

According to one aspect, a fuel cell system for a vehicle is proposed here, which comprises a cooling circuit having a fuel cell assembly and at least one cooler which is fluidically connected to the fuel cell assembly. The fuel cell system furthermore contains a data ascertainment device and a control device. The data ascertainment device is designed to ascertain first data representative of a first cooling power of the cooler. The first cooling power is an actual cooling power. The control device is designed to obtain, in particular to receive, the first data representative of the first cooling power of the cooler, to ascertain second data, which are representative of a second cooling power of the cooler at a predetermined maximum permissible temperature of a coolant provided for circulating in the cooling circuit, on the basis of the first data, to establish a maximum permissible electric output of the fuel cell assembly on the basis of the second data, and to control an electric output to be generated by the fuel cell assembly such that it is at least temporarily at most as high as the maximum permissible electric output.

This enables the output of the fuel cell system to be controlled/regulated so it is adapted to the ambient conditions and/or driving situation of the vehicle in a comparatively simple manner. The inventors have recognized that the actual cooling power (i.e., the instantaneous actual cooling power) of the cooler of a vehicle fuel cell system can depend significantly on the ambient conditions and the travel speed of the vehicle. For example, the actual cooling power is higher at low ambient temperatures (with otherwise identical boundary conditions) than at high ambient temperatures. Furthermore, the actual cooling power can be less at low (travel) speeds of the vehicle or a low air mass flow through the cooler than at high speeds.

In that the maximum permissible electric output of the fuel cell assembly (so-called permissible maximum output) is established as a function of the second data, which represent the second cooling power of the cooler at the predetermined maximum permissible temperature of the coolant, a comparatively simple control algorithm of the fuel cell assembly can be implemented indirectly as a function of the actual cooling power. In this way, the risk of overheating of the fuel cell assembly can be reduced in an uncomplicated and effective manner. As a result, the fuel cell system can be operated comparatively stably with respect to its permissible maximum output, particularly because the cooling by way of the cooling circuit is very sluggish in comparison to the electric output regulation. For this reason, the fuel cell system can additionally have a longer lifetime.

In the context of the present disclosure, the term “cooling power” is to be understood as the total heat flow ([internal] energy per unit of time=power) which is emitted at the cooler from the coolant to the surroundings.

The prefix “actual” designates an instantaneous real value of the physical variable subsequently specified. For example, the actual cooling power is the instantaneous real cooling power.

The ascertainment “on the basis” of specific data or a specific physical variable means that the respective data/the respective physical variable are taken into consideration in the ascertainment.

(First/second) data representative of the first/second cooling power can be the first/second cooling power itself or those data from which the respective cooling power, optionally with further consideration of temporally constant stored parameters, can be determined, preferably uniquely. The data representative of the first cooling power can be at least the temporally variable part of the data set for ascertaining the second cooling power, preferably the entirety of data from which the second cooling power can be uniquely ascertained.

It was stated that the second data are representative of the second cooling power of the cooler at a predetermined maximum permissible temperature of the coolant provided for circulating in the cooling circuit. The term “predetermined maximum permissible temperature” designates in this case a predetermined coolant temperature (numeric value) stored in the fuel cell system, in particular in the control device. The predetermined maximum permissible temperature is insofar used as a threshold value, upon the exceeding of which a safety power reduction of the fuel cell system is initiated by way of the control device. The safety power reduction can take place such that the maximum permissible electric output of the fuel cell system is throttled to a predetermined value, which is in particular independent of the second cooling power, for example, 20% of the electric maximum output of the fuel cell assembly. Preferably, the predetermined maximum permissible temperature is between 85° C. and 100° C., most preferably between 88° C. and 95° C.

The maximum permissible electric output of the fuel cell assembly in the context of the present disclosure can be that electric output which the fuel cell assembly can provide during operation under full load. The maximum permissible electric output is preferably temporally variable in accordance with the second cooling power.

The control device can be designed as a control unit and can control the operation of the fuel cell assembly. In this disclosure, a control can include or be a regulation (in the meaning of regulation technology). Accordingly, the control device can be designed as a control/regulating device, thus as a device for controlling and/or regulating the electric output to be generated. The electric output to be generated can be a control variable of a control loop here.

The fuel cell system proposed here is intended in particular for a motor vehicle (e.g., passenger vehicles, motorcycles, utility vehicles) and/or preferably for providing the energy for at least one drive machine for locomotion of the (motor) vehicle. In addition, the fuel cell system can be provided for a differently designed vehicle, such as an aircraft or water vehicle. The fuel cell assembly of the fuel cell system can contain at least one fuel cell. In its simplest form, a fuel cell is an electrochemical energy converter which converts fuel (such as hydrogen) and oxidant (such as air, oxygen, and peroxides) into reaction products and produces electricity and heat at the same time. If the fuel cell assembly contains multiple fuel cells, they can be stacked. The fuel cell assembly can insofar be a single fuel cell or a fuel cell stack. The fuel cell or the fuel cell stack can be configured as part of the cooling circuit, as explained in more detail below, to have the coolant flow through it.

The cooling circuit is preferably provided for the temperature control of the fuel cell assembly. For this purpose, the cooling circuit preferably defines a coolant path, which leads from the cooler via a feed line to the fuel cell assembly and further via a return line back to the cooler and/or along which the coolant can circulate between the cooler and the at least one fuel cell. The cooler is preferably arranged here to have air flow through it during operation. This flow of the air through the cooler can be assisted by a fan.

In one variant, the cooling circuit can furthermore contain a bypass (bypass line), which can connect the feed line to the return line. The bypass can be connected in parallel with the cooler to the feed line and the return line in order to permit the coolant to bypass the cooler. The bypass therefore preferably branches off, in a circulation direction of the coolant, from the return line extending from the fuel cell assembly to the cooler and opens at an orifice point into the feed line leading to the fuel cell assembly. A three-way valve preferably controllable by way of the control device can be provided in order to cause the coolant to optionally (at least partially) flow back to the fuel cell assembly via the bypass or via the cooler. The orifice point is preferably arranged in the cooling circuit upstream of the conveyance device provided for causing the coolant to circulate.

In detail, the coolant path preferably has a first coolant path section extending through the cooler, a second coolant path section determined by the feed line, a third coolant path section extending through the fuel cell assembly, and/or a fourth coolant path section determined by the return line. In addition, it is conceivable that the coolant path extends through further components through which the coolant flows during operation of the fuel cell system, such as further heat exchangers, valves, or sensors, for example. In particular, the cooling circuit can have at least one conveyance device for the coolant. The at least one conveyance device is preferably designed as a pump. The at least one conveyance device is advantageously provided on the feed line, most preferably closer to the fuel cell assembly than to the cooler. The coolant heated by way of the fuel cell assembly can thus flow in the cooling circuit from the fuel cell assembly into the at least one cooler, where it then cools down, before it subsequently flows back into the fuel cell assembly.

The cooler (also radiator) can be a vehicle cooler, in particular a liquid cooler, which is preferably arranged for the travel wind to flow against it and/or through it. It is preferably designed as a heat exchanger. For example, the at least one cooler can be provided frontally on the vehicle front, in particular on the front end of the vehicle, or as a wheel housing cooler on a wheel housing. If the cooling circuit contains multiple coolers, these coolers can be arranged at various ones of the above-mentioned points on the vehicle (in particular front end/on the wheel housing). The first coolant path section extending through the respective cooler can fluidically connect (at least) one inlet of the respective cooler to (at least) one outlet of the respective cooler.

The coolant can be a fluid, in particular a liquid or a gas. The coolant can furthermore be able to be filled into the cooling circuit or can be part of the cooling circuit. Although coolant is referred to here, this coolant is not only restricted to cooling. Rather, the coolant can also be used for heating or for the temperature control in general of the fuel cell assembly. The coolant is preferably water or an aqueous solution, for example, having antifreeze additive. The cooling circuit can also be used for uniform distribution of heat (i.e., for reducing, limiting, or avoiding temperature gradients) within the fuel cells or within the fuel cell stack.

The data ascertainment device can be provided to detect operating parameters from the fuel cell system, in particular from the cooling circuit, from the cooler, from the coolant, and/or from the fuel cell assembly, preferably itself by way of suitable sensors (transmitters). The operating parameters can in this case in particular be physical variables such as a temperature, pressure, or a mass flow or variables derived therefrom (such as a pressure difference). The operating parameters to be ascertained or detected by way of the data ascertainment device can include a velocity of the vehicle and/or a velocity of the fluid (in particular air) flowing into the cooler. The first data can contain values associated with these operating parameters.

The data ascertainment device is therefore preferably configured (set up/designed) to ascertain a value of at least one of the following operating parameters, in particular to detect it by way of a respective corresponding sensor:
a temperature of the coolant at the at least one inlet of the cooler;
a temperature of the coolant at the at least one outlet of the cooler;
an ambient temperature of the vehicle, in particular a temperature of the air flowing into the cooler (in relation to the air flow) upstream of the cooler;
a velocity of the vehicle;
a coolant pressure at the inlet of the fuel cell assembly;
a coolant pressure at an outlet of the fuel cell assembly;
a differential pressure across a predetermined component of the fuel cell system, in particular across a pressure aperture;
a mass flow of coolant flowing through the fuel cell assembly; and/or
a mass flow of coolant flowing through the cooler.

Each of these values can be an instantaneous (current) value, a so-called actual value. That is to say, each of these temperatures can be an actual temperature or an actual ambient temperature. The velocity can be an actual velocity. Each coolant pressure can be an actual coolant pressure. Each mass flow can be an actual mass flow.

The first cooling power and the second cooling power can temporally vary. In the context of the present disclosure, (first/second) data representative of the first/second cooling power can therefore be the first or second cooling power itself or those data from which the respective cooling power can be determined, preferably uniquely, possibly with further consideration of temporally constant parameters. The control device can accordingly be configured to determine the first cooling power based on these first data. The first data can then contain the first cooling power. Accordingly, the control device can determine the second data, in particular the second cooling power, based on the first data or directly on the first cooling power.

If the first data contain the actual temperature of the coolant at the inlet of the cooler and the actual temperature of the coolant at the outlet of the cooler, the control device can preferably ascertain the first and/or second cooling power on the basis of a first temperature difference between the actual temperature of the coolant at the inlet of the cooler and the actual temperature of the coolant at the outlet of the cooler. In particular, the first cooling power can be ascertained such that it is directly proportional to the first temperature difference, to the actual mass flow of the coolant through the cooler or the fuel cell assembly, and/or to a specific heat capacity of the coolant. The first cooling power can be calculated here according to the following formula:

$${\dot{Q}}_{1} = \dot{m} {c}_{p} ( {T}_{1} - {T}_{2} )$$

In this case, \dot{Q}₁ designates the first cooling power, \dot{m} designates the actual mass flow of the coolant through the cooler, cₚ designates the specific heat capacity of the coolant, T₁ designates the actual temperature at the inlet of the cooler, and T₂ designates the actual temperature at the outlet of the cooler.

The (actual) mass flow can be detected by way of a mass flow sensor or can be calculated as a function of a pressure difference between a coolant pressure at the inlet of the fuel cell assembly and a coolant pressure at the outlet of the fuel cell assembly. In the latter case, the data ascertainment device can have a pressure detection device which is arranged to detect the coolant pressure at the inlet of the fuel cell assembly and the coolant pressure at the outlet of the fuel cell assembly and provide them to the control device. The control device can be configured to ascertain the second cooling power based on the pressure difference. The control device can be configured to determine the (actual) mass flow based on the pressure difference. For this purpose, for example, a first data set in the form of a predetermined first function or a first conversion table (so-called first lookup table) can be stored in the control device. This first data set can be suitable for uniquely (one to one) assigning the pressure difference to the mass flow. Instead of the pressure difference, an operating point of a conveyance device for the coolant (coolant pump) can also be used. In addition, it is conceivable to determine (ascertain) the actual mass flow of the coolant on the basis of a speed of the coolant pump, an electric output consumption of the coolant pump, and/or a setting of the three-way valve.

If the first data contain the ambient temperature of the vehicle, in particular the (actual) temperature of the air flowing into the cooler upstream of the cooler, and a velocity of the vehicle, the control device can determine the first cooling power by way of a second data set stored in the control device, for example, likewise in the form of a predetermined function or a conversion table (so-called lookup table). The first cooling power can rise with rising velocity (for example directly proportionally). The first cooling power can fall with rising ambient temperature or temperature of the air flowing into the cooler. In particular, the first cooling power can be indirectly proportional to the mentioned temperature. The velocity of the vehicle can be received by way of the data ascertainment device, in particular from a velocity measuring device of the vehicle, or can be determined by way of a velocity sensor.

It was stated that the control device can determine the second data, in particular the second cooling power, based on the first data or directly on the first cooling power. Accordingly, the statements made hereinafter for the second cooling power apply analogously to the second data.

The second data are provided to estimate how much heat can be emitted to the surroundings by way of the cooling circuit at the predetermined maximum permissible temperature (i.e. the highest temperature suitable for the continuous operation of the fuel cell assembly). The ascertainment of the second cooling power can include estimating the second cooling power. The second cooling power can be greater than the first cooling power here. The second cooling power can be intended to be, with constant boundary conditions (ambient temperature, velocity of the vehicle, and operation of the fuel cell assembly at the maximum permissible electric output), the limiting value achievable by the time-dependent first cooling power (limit time to infinity).

The control device can ascertain the second cooling power based on a second temperature difference between the maximum permissible temperature of the coolant and the ambient temperature of the vehicle. The ascertainment can be carried out by way of a third data set stored in the form of a further predetermined function or a further conversion table (lookup table). The second cooling power can be represented here in the third data set as directly proportional to the second temperature difference and/or to the reciprocal of a third temperature difference between the temperature at the inlet of the cooler and the ambient temperature. The second cooling power \dot{Q}₂ can be ascertained, in particular estimated, by way of the control device in particular according to the following formula:

$${\dot{Q}}_{2} = {\dot{Q}}_{1} \cdot ( {T}_{max} - {T}_{u} ) / ( {T}_{1} - {T}_{u} ) ,$$

In this case, \dot{Q}₁ designates the first cooling power, Tₘₐₓ designates the maximum permissible temperature of the coolant, Tᵤ designates the ambient temperature of the vehicle, and T₁ designates the actual temperature of the coolant at the inlet of the cooler. This relationship between first cooling power and second cooling power can be derived/estimated starting from the following equation:

$${\dot{Q}}_{2} / ( {T}_{max} - {T}_{u} ) = {\dot{Q}}_{1} / ( {T}_{1} - {T}_{u} )$$

The control of the electric output to be generated can include regulating this power. The control device can thus be configured to carry out a power regulation of the fuel cell assembly in consideration of the maximum permissible electric output established on the basis of the second data. The maximum permissible electric output can be directly proportional to the second cooling power. This functional relationship can be stored in the control device and used by the control device for the calculation of the maximum permissible electric output.

The control device can advantageously be designed to permit the maximum permissible electric output to be exceeded temporarily, in particular for a short time. This exceeding can be enabled in consideration of the total heat capacity of the fuel cell assembly and/or the coolant. The inventors have recognized that short-term exceeding of the maximum permissible electric output does not necessarily result in exceeding the predetermined maximum permissible temperature of the coolant. The control device can accordingly be designed to control the electric output to be generated by the fuel cell assembly such that during a period of time, it is greater than the mentioned maximum permissible electric output (also “first maximum permissible electric output” hereinafter) and is at most as high as a further maximum permissible electric output (also “second maximum permissible electric output”). The first maximum permissible electric output can be a stationary power and/or the second maximum permissible output can be a (dynamic) peak or maximum power.

The combination of maximum permissible electric output and period of time can be established here by the control device so that the product of these two values divided by a fourth temperature difference between the predetermined maximum permissible temperature and the actual temperature of the coolant at the inlet of the cooler (in particular before permitting the first maximum permissible electric output to be exceeded) corresponds to the heat capacity (ratio of the heat supplied to the fuel cell assembly to the temperature increase thus caused). The control device can thus be configured to ascertain the fourth temperature difference and to multiply it by the mentioned heat capacity of the fuel cell assembly and/or the coolant (which is stored in the control device, for example), in order to determine the total amount of heat absorbable by these components. The control device can then establish the second maximum permissible electric output and the period of time on the basis of this heat as indicated above.

The period of time can be predetermined, for example stored in the control device. Alternatively, the control device can be configured to establish the period of time. For example, the period of time is at most 30 seconds, at most 15 seconds, or at most 10 seconds. The period of time can be established by way of the control device on the basis of the (predetermined) heat capacity of the entire cooling circuit and/or the actual mass flow of the coolant. In this way, the electric energy required for an acceleration process of the vehicle (for example during an overtaking process) can be generated with comparatively little delay. While the second maximum permissible electric output can only be released for a short time, the control device is designed to permit a continuous operation of the fuel cell assembly at the first maximum permissible electric output.

The vehicle proposed here contains a fuel cell system described above in detail. In addition, the vehicle can have a velocity ascertainment device, which contains, for example, a velocity or acceleration sensor. The velocity ascertainment device can have a communication connection to the data ascertainment device and can transmit the velocity of the vehicle to the data ascertainment device. Alternatively, a navigation system of the vehicle can transmit the velocity of the vehicle to the data ascertainment device instead of the velocity ascertainment device. The statements made for the velocity apply accordingly to the ambient temperature of the vehicle.

The method proposed here is provided for controlling (at least) the fuel cell assembly of the fuel cell system and comprises the following steps: receiving the first data representative of the first cooling power of the cooler; ascertaining the second data, which are representative of the second cooling power of the cooler at the predetermined maximum permissible temperature of the coolant, on the basis of the first data; establishing the maximum permissible electric output of the fuel cell assembly on the basis of the second data; and controlling the electric output to be generated by the fuel cell assembly such that it is at least temporarily at most as high as the maximum permissible electric output.

In addition, the method can have any, in particular all, of the above-explained features, in particular functions, of the fuel cell system, in particular the control device, as method steps.

The computer program contains commands which, upon execution of the above-explained method by a control device, cause the control device to carry out the method. The commands can be provided in particular to cause the control device to control the fuel cell system, in particular the fuel cell assembly, according to the method. A power regulation of the fuel cell assembly can take place up to the (first or second) maximum permissible electric output. To obtain or receive the first data, the control device can be connected to the data ascertainment device or the data ascertainment device can be part of the control device.

The computer program product is stored on a computer-readable medium disclosed here, such as a data carrier (such as a hard drive or a USB stick).

In other words, the technology disclosed here relates to a method for limiting the output of the fuel cell assembly via the vehicle cooler performance. At each operating point in time of the fuel cell system, a determination of the current cooling power (“radiator performance”) is carried out, which is used for an estimation of the maximum permissible/released fuel cell output. The coolant volume flow is determined from a pressure loss measurement across the fuel cell assembly (stack) or the operating point of the coolant pump. The current heat emission of the cooler is determined using the temperatures before and after the cooler (radiator) via a simple heat balance. The relationship between system waste heat and electric system output is known and can be used for output limiting. Because it is a transient process, the heat capacity of the cooling circuit and of the stack itself can also be taken into consideration in the heat balance.

This enables the fuel cell system to be operated more stably and reliably. Operation at high ambient temperatures is possible. A trailing effect caused by greatly differing inertias of coolant temperature and electric fuel cell output occurs more rarely, in which a load jump only results in a temperature increase several seconds later. A load profile can be avoided in which it is possible to jump from low load to full load and back to low load and the coolant temperature only reaches the maximum values, which can be above the maximum permissible limit depending on the radiator performance, after the reduction to the low load. The coolant temperature in the cooling circuit of the fuel cell system can more easily be kept below a defined temperature threshold for safety and component protection.

The control method can be summarized as follows (Q designates the heat flow in this case):
1. The first cooling power can be determined (determination of radiator performance at the current coolant temperature T₁ at the cooler inlet) as follows:

$$Qrad = m\_fl \times cp \times ( {T}_{1} - {T}_{2} )$$

m_fl=f {dp coolant} (characteristic map)
2. The second cooling power at maximum coolant temperature at the inlet of the cooler (T_{1, max}=90° C.) can be determined:

$$Q / ITDact = Qrad / ( {T}_{1} - {T}_{u} ) = > Qrad , 90 = Q / ITDact \times ( 90 - Tamb )$$

3. The maximum fuel cell stack continuous net output Pnet,max,dauer can be determined as follows:

$${P}_{net , max , dauer} = f \{ Qrad , 90 \} ( characteristic map )$$

4. The maximum fuel cell stack 10 second net output P_{net,max,10s} can be determined as follows (Cp_fuel cell stack is the heat capacity of the fuel cell assembly or the fuel cell stack):

$${P}_{net , max , 10 s} = f \{ Quad , 90 + {C}_{p \_} fuel cell stack \}$$

The following conditions can apply:
1. T₁>75° C.
2. If a bypass is provided: mass flow part through the cooler greater than 95%.

The technology disclosed here will now be explained on the basis of the figures.

### BRIEF DESCRIPTION OF THE DRAWINGS

In the schematic figures, which are not to scale:

FIG. 1 shows a first variant of a fuel cell system;

FIG. 2 shows a second variant of a fuel cell system;

FIG. 3 shows a third variant of a fuel cell system;

FIG. 4 shows a vehicle, in particular a motor vehicle, having the fuel cell system from FIG. 3;

FIG. 5 shows a method for controlling a fuel cell assembly of the fuel cell system from FIG. 1; and

FIG. 6 shows a computer program product having commands for carrying out the method from FIG. 5.

### DETAILED DESCRIPTION OF THE DRAWINGS

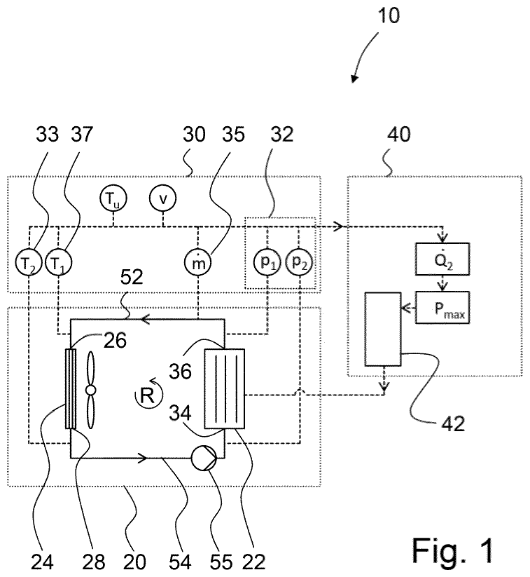

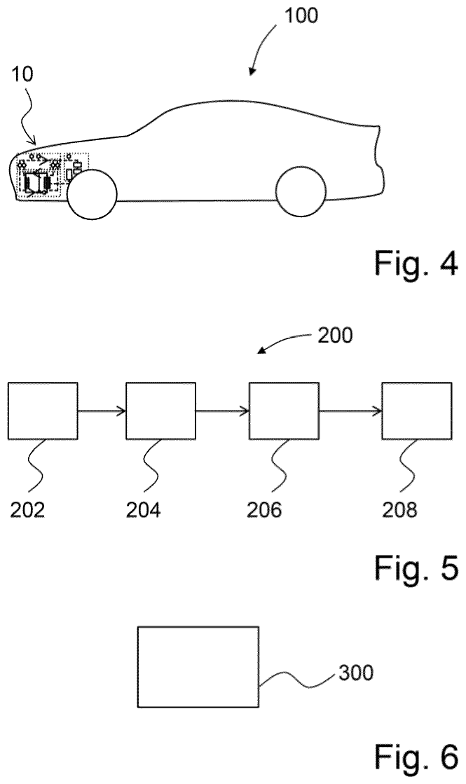

FIG. 1 shows a fuel cell system, which is provided for use in a vehicle 100 shown in FIG. 4, in particular a motor vehicle. The vehicle 100 can be, for example, a passenger vehicle.

The fuel cell system 10 comprises a cooling circuit 20, a data ascertainment device 30, and a control device 40. The data ascertainment device 30 is shown separately from the control device 40 in FIG. 1. However, this only serves for clarity. The data ascertainment device 30 can be at least partially integrated in the control device 40.

The cooling circuit 20 is provided for circulating a coolant in a circulation direction R. The cooling circuit 20, in particular a coolant path of the cooling circuit 22, extends from a cooler 24 via an outlet 28 of the cooler 24, further via a feed line 54, a conveyance device 55, provided in the feed line 54, in the form of a coolant pump to an inlet 34 of a fuel cell assembly 22. The fuel cell assembly 22 is a fuel cell stack here; the coolant path extends through the fuel cell assembly 22. An outlet 36 of the fuel cell assembly is connected via a return line 52 to an inlet 26 of the cooler 24. The cooler 24 is provided for installation on a front end of the vehicle 100 against which travel wind flows during travel. Alternatively, the cooler 24 can be designed as a wheel housing cooler.

The data ascertainment device 30 contains multiple sensors for detecting diverse cooling-specific physical variables, wherein these variables are corresponding first data representative of a first cooling power of the cooler 24. That is to say, the first cooling power can be calculated uniquely from the first data ascertained by way of the data ascertainment device 30. In an alternative variant, the data ascertainment device 30 can ascertain at least a part of the first data (non-sensorially), for example, read the data from the vehicle 100 or from a memory of the control device 40.

In the variant from FIG. 1, the data ascertainment device 30 contains a first temperature sensor 33 and a second temperature sensor 37. The first temperature sensor 33 is configured to detect (i.e. to measure) an actual temperature of the coolant at the inlet 26 of the cooler 24. The second temperature sensor 37 is configured to detect an actual temperature of the coolant at the outlet 28 of the cooler 24. The actual temperature of the coolant at the inlet 26 and the actual temperature of the coolant at the outlet 28 form a part of the first data. In addition, the data ascertainment device 30 contains a mass flow sensor 35, which is designed to detect an actual mass flow of coolant flowing through the return line. This actual mass flow forms a further part of the first data. In the present variant, because of conservation of mass, it is of the same size at least in a section of the feed line 54, at least a section of the cooler 24, and/or at least a section of the fuel cell assembly 22 as detected at the return line 52. A specific heat capacity of the coolant, which is also part of the first data, can be stored in the memory.

The control device 40 obtains (here: receives from outside the control device 40) the first data and processes them. The first cooling power is calculated in this case. The first cooling power is the (actual) cooling power currently provided by the cooler (emitted heat flow (unit J/s)); it can be determined in particular from the actual mass flow, the specific heat capacity of the coolant, and a first temperature difference between the actual temperature of the coolant at the inlet 26 minus the actual temperature of the coolant at the outlet 28. Alternatively, the first cooling power can be calculated from an ambient temperature of the vehicle 100 and a current travel velocity of the vehicle 100. For this purpose, a predetermined function is stored in the control device, which assigns the first cooling power to the ambient temperature and the current travel velocity.

Second data are then ascertained by way of the control device, which are representative of a second cooling power of the cooler 24 at a predetermined maximum permissible temperature of the coolant. These second data can be ascertained on the basis (in consideration) of the first data. They can be or comprise the second cooling power. The predetermined maximum permissible temperature can be between 85° C. and 100° C. In this variant, this temperature is at 90° C.

The control device 40 is furthermore configured for the purpose of calculating the second cooling power according to the following formula:

$${\dot{Q}}_{2} = {\dot{Q}}_{1} \cdot {T}_{max} - {T}_{u} / {T}_{1} - {T}_{u} ,$$

Therein, \dot{Q}₁ designates the first cooling power, Tₘₐₓ designates the maximum permissible temperature of the coolant, Tᵤ designates the ambient temperature of the vehicle 100, and T₁ designates the actual temperature of the coolant at the inlet 26 of the cooler 24. The temperature of the coolant in the cooling circuit can be regulated reliably and easily in consideration of this second cooling power when the maximum permissible electric output is established. For this reason, the control device 40 is designed to establish the maximum permissible electric output of the fuel cell assembly 22 on the basis of the second data, in particular the second cooling power, and to control the electric output to be generated by the fuel cell assembly 22 such that it is at least temporarily at most as high as the maximum permissible electric output.

The maximum permissible electric output is intended for a continuous operation of the fuel cell assembly 22 at the maximum permissible electric output; i.e., when the fuel cell assembly is operated at the maximum permissible electric output, it is relatively easy to avoid the fuel cell assembly 22 overheating. In this case, the maximum permissible electric output is taken into consideration in the regulation (in particular output regulation) of the operation of the fuel cell assembly 22 by way of the control device 40 (see section 42 of the control device 40).

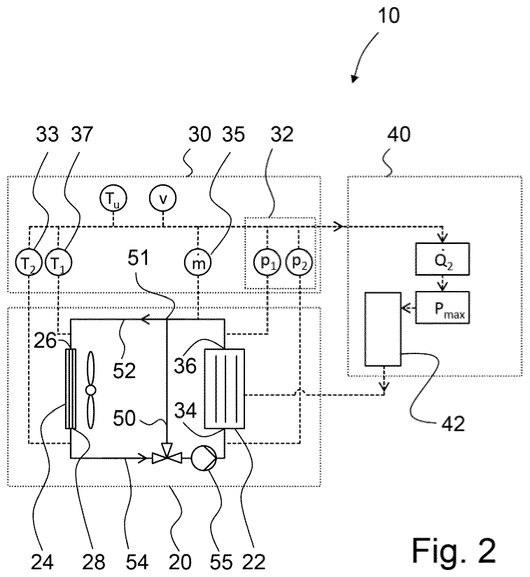

A further fuel cell system from FIG. 2 differs from the fuel cell system from FIG. 1 in that the cooling circuit 20 additionally contains a bypass 50, which branches off from the return line 52 extending from the fuel cell assembly 22 to the cooler 24 in the circulation direction R of the coolant and opens at an orifice point into a feed line 54 leading to the fuel cell assembly 22. A three-way valve (in particular a 3/2 way valve) in the feed line or return line 54, 52 is settable by way of the control device 40 and provided to cause at least a part of the coolant flowing out through the outlet 36 of the fuel cell assembly 22 to flow through the bypass 50 and thus bypass the cooler 24. Accordingly, only an actual mass flow part of the coolant flowing through the cooler 24 instead of the entire actual mass flow of the coolant flowing through the outlet 36 is incorporated in the calculation of the first cooling power in this case. To determine the actual mass flow part, the mass flow sensor 35 can be provided upstream of a branching point 51 of the bypass 50 in the return line 52. Otherwise, the fuel cell system 10 from FIG. 2 has all the features of the fuel cell system from FIG. 1.

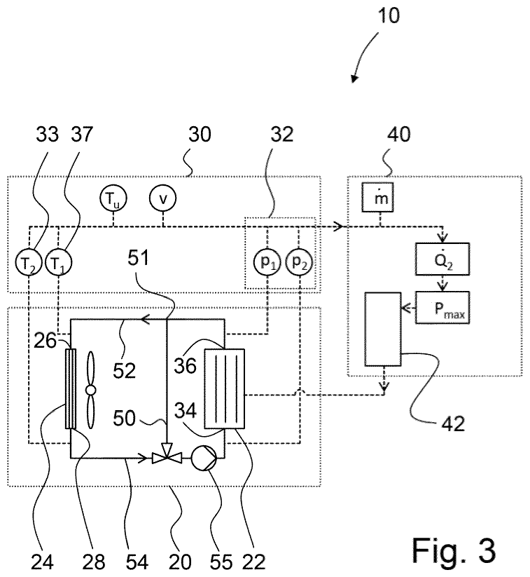

A further fuel cell system from FIG. 3 differs from the fuel cell system from FIG. 1 or 2 in that the control device 40 is configured to ascertain the actual mass flow and the second cooling power based on a pressure difference between a coolant pressure at the inlet 34 of the fuel cell assembly 22 and a coolant pressure at the outlet 36 of the fuel cell assembly 22. Alternatively, the actual mass flow can be ascertained based on an operating parameter, in particular an electric output or a current, of the conveyance device 55 provided for causing the coolant to circulate. To detect (in particular measure) these coolant pressures, the data ascertainment device 30 contains a pressure detection device 32. This enables the mass flow sensor 35 to be omitted in order to save costs. In contrast, in the variants from FIGS. 1 and 2, the pressure detection device 32 is optional. Otherwise, the fuel cell system 10 from FIG. 3 has all the features of the fuel cell system from FIG. 1 or 2.

In each of the variants from FIGS. 1 to 3, the control device 40 can additionally be designed to control the electric output to be generated by the fuel cell assembly 22 such that it is greater during a certain period of time than the maximum permissible electric output and is at most as high as a further maximum permissible electric output. The period of time is comparatively short at 5 to 30 seconds, preferably approximately 10 seconds. With this type of control, the heat capacity of the fuel cell assembly can be better utilized. The period of time can be predefined and stored in the control device 40 or can be determined dynamically, for example on the basis of the first cooling power, by the control device 40.

FIG. 4 shows the vehicle 100 having the fuel cell system 10. The cooler 24 is provided here frontally on the frontmost front (at the front end) of the vehicle 100 in order to have the travel wind flow against it (in particular directly) and provide efficient cooling.

A method 200 which is shown very schematically in FIG. 5 is provided for controlling the fuel cell assembly 22 as described above. In a first method step 202, the control device 40 obtains or receives the first data representative of the first cooling power of the cooler 24. In step 204, it subsequently ascertains the second data, which are representative of the second cooling power of the cooler 24 at the predetermined maximum permissible temperature of the coolant, on the basis of the first data. In a first step of determination 206, the maximum permissible electric output of the fuel cell assembly 22 is then determined on the basis of the second data. In step 208, the electric output to be generated by the fuel cell assembly 22 is controlled such that it is at least temporarily at most as high as the maximum permissible electric output. A computer program 300 is shown in FIG. 6. This computer program contains commands in order, upon execution of the method 200 by the control device 40, to cause the control device 40 to carry out the method 200.

For reasons of readability, the expression “at least a/one” is sometimes omitted for simplification in this disclosure. If a feature of the technology disclosed here is described in the singular or in an undefined manner (e.g. the/a cooler, a/the fuel cell assembly, a/the data ascertainment device, etc.), its plural is also intended to be disclosed at the same time (e.g. the at least one cooler, the at least one fuel cell assembly, the at least one data ascertainment device, etc.). At least in some sections means in some sections or completely here. The term “essentially” in the context of the technology disclosed here comprises in each case the precise property or the precise value as well as in each case deviations unimportant for the function of the property/the value, for example, due to production tolerances.

The preceding description of the present invention serves only for illustrative purposes and not for the purpose of restricting the invention. Various changes and modifications are possible in the context of the invention without departing from the scope of the invention and its equivalents.

1-16. (canceled)

17. A fuel cell system for a vehicle, the fuel cell system comprising:
a cooling circuit having a fuel cell assembly and a cooler fluidically connected to the fuel cell assembly;
a data ascertainment device, which is designed to ascertain first data representative of a first cooling power of the cooler; and
a control device,
wherein the first cooling power is an actual cooling power,
wherein the control device is designed
to obtain the first data,
to ascertain second data based on the first data,
to determine a maximum permissible electric output of the fuel cell assembly based on the second data, and
to control an electric output to be generated by the fuel cell assembly such that it is at least temporarily at most as high as the maximum permissible electric output, and
wherein the second data are representative of a second cooling power of the cooler at a predetermined maximum permissible temperature of a coolant provided for circulating in the cooling circuit.

18. The fuel cell system according to claim 17,
wherein the control device is configured to determine the first cooling power based on the first data,
wherein the second data contain the first cooling power.

19. The fuel cell system according to claim 17,
wherein the first data contain an actual temperature of the coolant at an inlet of the cooler and an actual temperature of the coolant at an outlet of the cooler, and
wherein the control device is designed to ascertain the first and/or second cooling power on the basis of a temperature difference between the actual temperature of the coolant at the inlet of the cooler and the actual temperature of the coolant at the outlet of the cooler.

20. The fuel cell system according to claim 17,
wherein the first data contain an ambient temperature of the vehicle and a velocity of the vehicle.

21. The fuel cell system according to claim 17,
wherein the control device is configured to ascertain the second data based on a temperature difference between the maximum permissible temperature of the coolant and an ambient temperature of the vehicle.

22. The fuel cell system according to claim 20,
wherein the control device is designed to ascertain the second cooling power according to the following formula:
$${\dot{Q}}_{2} = {\dot{Q}}_{1} \cdot ( {T}_{max} - {T}_{u} ) / ( {T}_{1} - {T}_{u} ) ,$$
wherein \dot{Q}₁ is the first cooling power, Tₘₐₓ is the maximum permissible temperature of the coolant, Tᵤ is the ambient temperature of the vehicle, and T₁ is the actual temperature of the coolant at the inlet of the cooler.

23. The fuel cell system according to claim 17,
wherein the data ascertainment device has a pressure detection device arranged to detect a coolant pressure at an inlet of the fuel cell assembly and a coolant pressure at an outlet of the fuel cell assembly and provide the coolant pressure at the inlet and the coolant pressure at the outlet to the control device,
wherein the control device is configured to ascertain the second cooling power based on a pressure difference between the coolant pressure at the inlet of the fuel cell assembly and the coolant pressure at the outlet of the fuel cell assembly.

24. The fuel cell system according to claim 17,
wherein the first data contain an actual mass flow of coolant flowing through the fuel cell assembly and/or through the cooler.

25. The fuel cell system according to claim 24,
wherein the control device is designed to determine the actual mass flow based on a pressure difference between the coolant pressure at the inlet of the fuel cell assembly and the coolant pressure at the outlet of the fuel cell assembly or based on an operating parameter of a conveyance device intended to cause the coolant to circulate.

26. The fuel cell system according to claim 17,
wherein the control device is designed to control the electric output to be generated by the fuel cell assembly such that, during a period of time, it is higher than the maximum permissible electric output and is at most as high as a further maximum permissible electric output.

27. The fuel cell system according to claim 26,
wherein the period of time is predetermined,
or wherein the control device is configured to determine the period of time.

28. The fuel cell system according to claim 17, further comprising:
a bypass branching off in a circulation direction (R) of the coolant from a return line extending from the fuel cell assembly to the cooler and opening at an orifice point into a feed line leading to the fuel cell assembly.

29. The fuel cell system according to claim 17,
wherein the control device is designed to permit a continuous operation of the fuel cell at the maximum permissible electric output.

30. A vehicle comprising a fuel cell system according to claim 17.

31. A method for controlling a fuel cell assembly of a fuel cell system according to claim 17, the method comprising:
obtaining the first data representative of the first cooling power of the cooler;
ascertaining the second data, which are representative of the second cooling power of the cooler at the predetermined maximum permissible temperature of the coolant, based on the first data;
determining the maximum permissible electric output of the fuel cell assembly based on the second data; and
controlling the electric output to be generated by the fuel cell assembly such that it is at least temporarily at most as high as the maximum permissible electric output.

32. A computer program comprising commands configured to cause the control device to carry out the method according to claim 31.
